(19) United States
(12) Patent Application Publication
(10) Pub. No.: US 2015/0242800 A1
(43) Pub. Date: Aug. 27, 2015

(54) Maintenance and Security Guide

(71) Applicant: GeoVector Corp., Portland, OR (US)

(72) Inventors: Peter Malcolm Ellenby, Portland, OR (US); Thomas Ellenby, San Jose, CA (US); John Ellenby, San Francisco, CA (US)

(73) Assignee: GeoVector Corp., Portland, OR (US)

(21) Appl. No.: 14/630,527

(22) Filed: Feb. 24, 2015

Related U.S. Application Data
(60) Provisional application No. 61/966,524, filed on Feb. 25, 2014.

(51) Int. Cl. G06Q 10/06

(52) U.S. Cl. CPC G06Q 10/063114

(57) ABSTRACT

A maintenance and security guidance system is formed of a computer-based processor made responsive to location, time of day, manual user inputs, among others to provide maintenance and security suggestions based upon information stored as site descriptors. In response to user requests in combination with present conditions such as time, location, operating state, etc., a database request is executed against stored site data to produce a resultset of site descriptors. These site descriptors are used both manually and automatically to assist maintenance and security workers in executing a routine in agreement with the prescribed parameters.

### BACKGROUND OF THE INVENTION

### Priority

This application claims priority from U.S. Provisional Application having Ser. No. 61/966,52.4 filed Feb. 25, 2014.

### FIELD

The following invention disclosure is generally concerned with electronic maintenance and security guidance systems including equipment and technique and more specifically concerned with electronic maintenance and security guidance systems which provide viewing and verification information to a user in response to various environmental, time and spatial states.

### RELATED SYSTEMS

Computer technologies have enabled remarkable changes to many of our everyday activities. From how we communicate with our families, to how we plan a journey—computers today greatly influence the manner in which we perform many activities. Even something such as maintenance and security can be greatly improved and enhanced by way of supporting computer systems. With the advent of inexpensive portable consumer electronics such at tablet computers, small hand-held computing systems and wearable devices like Google Glass, great opportunity arises for maintenance and security workers to benefit from these advances.

Currently maintenance and security routines and tasks are initiated, completed and recorded in a number of ways. Most of these such as punching a time clock, or signing a form located on the site where the particular task is to be completed leave many aspects of the task to be performed un-reported and the verification of full completion uncertain.

### SUMMARY OF THE INVENTION

Comes now, Peter, Thomas and John Ellenby with inventions of maintenance and security guidance systems including computing apparatus for directing a maintenance and security worker where the apparatus provides suggestions regarding maintenance routines, security functions, and site maintenance and security verification, among others. It is a primary function of these maintenance and security guidance systems to provide computer based apparatus and methods which respond to various stimuli by providing suggestions to an interested maintenance and security worker how one may best proceed to accomplish the desired maintenance and security task and ensure all the desired tasks are completed and notification can be speedily provided by wireless or other communication means to supervisory and oversight organizations.

An electronic maintenance and security worker guidance system includes a preprogrammed, application-specific computer arranged to recall data from a library of stored maintenance and security descriptors. Maintenance and security descriptors are encoded, devised and provided to the library in advance of use of the systems. A maintenance and security descriptor includes specification of a maintenance and security plan and maintenance and security parameters including but not limited to: maintenance and security course, site specifications, site information, surrounds information, maintenance and security status, and others. Upon various of these program stimuli, the computer by way of a query engine may recall at least one maintenance and security descriptor of which certain details may be presented graphically or textually at a user interface such as a display or monitor, or by voice to a headset or speaker. In accordance with maintenance and security details suggested, a maintenance and security workers may respond by manipulating her position, attention or focus, in agreement with the maintenance and security descriptor details.

A maintenance and security task such as a walking maintenance and security routine or driving maintenance and security routine is realized where a set of related site or equipment descriptors is presented serially in a manner in which a maintenance and security worker can proceed with a visit to a plurality of these sites or equipment. For example, a plurality of site descriptors all associated with an oil and gas refinery may be presented serially whereby a maintenance and security worker may follow a route which is comprised of each site descriptor in turn moving from one site to the next to be led about the most important equipment of the refinery. Alternatively, a guided maintenance and security routine of these systems may also include a walking maintenance and security of a single piece of equipment such as an oil derrick, or a single site such as a well head. Site descriptors each relating to the oil derrick can be dispensed serially with respect to a logical walking path in a manner whereby a maintenance and security worker may walk about, visiting each part to be inspected and maintained or fixed in accordance with the specified parameters, to form a still image visual documentary of the tasks performed and also record the maintenance or security task being performed by checking it off a list and also with photographic time and date stamped images of the completed routines and tasks

In general, these systems are formed of the following electronic modules coupled together as described. A programmed computer arranged with stored application-specific program code and a query engine coupled to a maintenance and security library. Query requests produce recall of a result set including at least one maintenance and security descriptor object which contains a maintenance and security specification including among others: site list, course, time plan, multi-media object histories, view points, view directions, maintenance and security settings, checklists, among others. These maintenance and security descriptors may be presented at a display type user interface where partial representations of them may be made visually and/or graphically. A maintenance and security worker may further interact with a result set of maintenance and security descriptors by scrolling through a plurality, for example by way of a control module unit, which further drives code execution with respect to the application.

A maintenance and security routine is presented when a recalled set of maintenance and security descriptors relates to a common theme or objective. For example, one type of maintenance and security routine is arranged about various sites of an oil refinery. Presented in a logical order, a plurality of maintenance and security site descriptors may be arranged one after another in a series which follows a spatial pattern. For example, a certain maintenance and security routine may be arranged to follow a prescribed maintenance and security route. A maintenance and security worker makes a visit to each site in the maintenance and security routine in accordance with maintenance and security descriptor details presented to them. Each routine may have a differing set of tasks and objectives for the worker to perform such as checking pumps, or ensuring doors and gates are locked and secure.

While providing worker maintenance and security routines and tasks is a primary function of these systems, a secondary but complementary function relates to past and future tasks and routines performed on a specific site or piece of equipment. A result set of site descriptors from which a maintenance and security task is comprised may include a user request with regard to the past maintenance of a specific object or feature of a site. Further, this request may include specification of a certain time period of particular interest such as bearing lubrication or checking the locks are functioning properly on a door. In response to these parameters, data including maintenance and security history may be provided to a user to advance a maintenance and security worker's knowledge about the site and its history.

Maintenance and security and history may be provided to a maintenance and security workers upon direct request. For example, a maintenance and security worker may specify “equipment maintenance and security of Oil Derrick number 12” from a menu of selections presented at a display monitor device or by other output means. The computer is arranged to execute an application where such maintenance and security worker's choices may be conveyed to the program logic. In response to such choice, the computer recalls a plurality of maintenance and security descriptors in agreement with that selection; i.e. maintenance and security descriptors which relate to equipment for the Oil Derrick number 12. As an alternative, a maintenance and security worker may set the computer into a “equipment ” mode—and the computer can rely upon a GPS or other position determining system, or inertial navigation to further specify a request query. That is, rather than a manual selection of “Oil Derrick number 12” a user may rely upon the computer's self-determination of location prior to recall of maintenance and security descriptors from which a maintenance and security is comprised. Indeed, a computer may run in various modes whereby options set by a user are provided in a default scheme or determined by measurement effect a manner in which a set of site descriptors from which a maintenance and security routine or task is comprised are recalled. The application supports various modes and each of these modes may cause a different query to be run against data stored in the maintenance and security library resulting in different maintenance and security plans and history.

In all cases, a programmed computer runs a request query against a library of stored maintenance and security descriptors to produce a result set including at least one site descriptor which may be presented at a user interface to realize a particular visitor maintenance and security in accordance with details of the maintenance and security specification.

### OBJECTIVES OF THE INVENTION

It is a primary object of the invention to provide a maintenance and security workers guidance system to ensure that maintenance procedures are followed and that task logging both local and remote is carried out such that records may be retrieved verifying that the maintenance and security procedures were in fact carried out as required.

It is an object of the invention to provide computer equipment which suggests parameters for maintenance and security workers in response to requests by a user-maintenance and security workers.

It is a further object to provide computer based consumer or industrial electronic equipment with a prescribed library of maintenance and security data.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present inventions will become better understood with regard to the following description, appended claims and drawings where:

FIG. 1 is a block diagram of a maintenance and security guidance system and its major sub-systems;

FIG. 2 is another important block diagram where a computer based system taught herein;

FIG. 3 illustrates additional important couplings between cooperative related systems and these tour guidance systems;

FIG. 4 presents another block diagram;

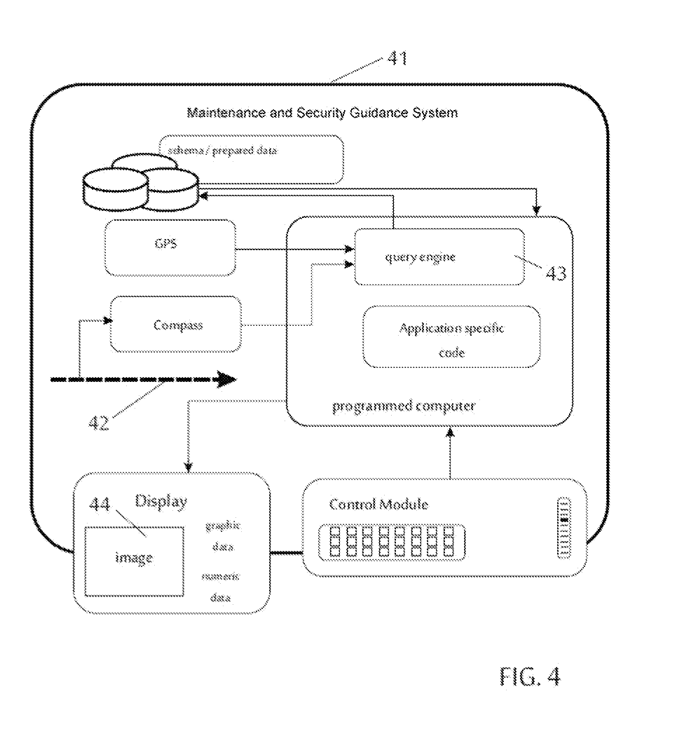

FIG. 5 presents another block diagram; and

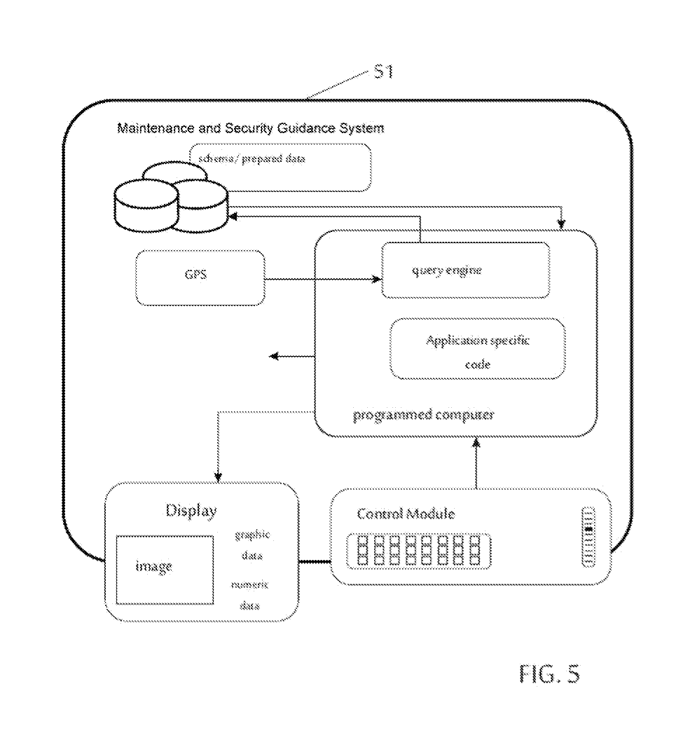

FIG. 6 illustrates additional important couplings between cooperative related systems and these tour guidance systems; specifically a head mounted display including a compass to determine the users viewing direction.

### DETAILED DESCRIPTION AND PREFERRED EMBODIMENTS

In accordance with each of preferred embodiments of the inventions; maintenance and security guidance systems are provided. It will be appreciated that each of the embodiments described include an apparatus and methods that the apparatus and methods of one preferred embodiment may be different than the apparatus and methods of another embodiment. Accordingly, limitations read in one illustrative example should not be carried forward and implicitly assumed to be part of any other alternative example.

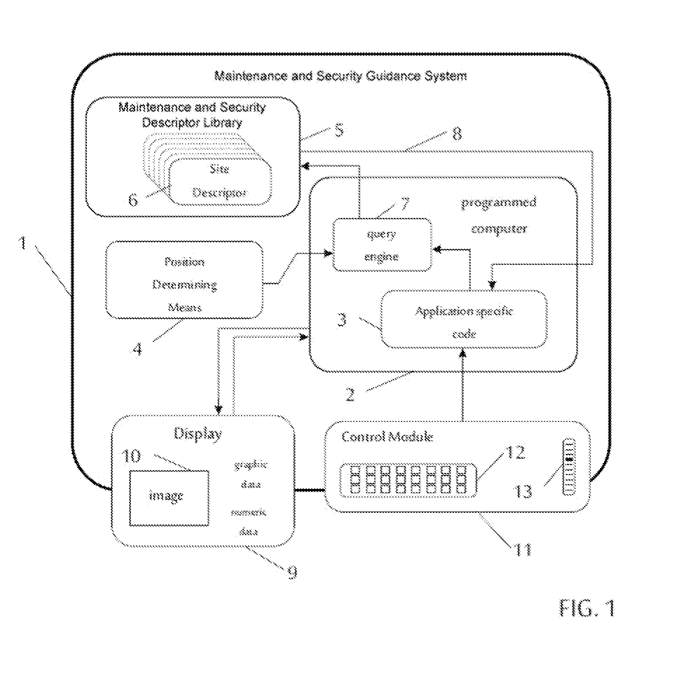

With reference to FIG. 1, one gains a most complete understanding of a general version of these maintenance and security guidance systems. An example maintenance and security guidance system 1 is primarily comprised of a programmed computer 2 with application-specific program code 3, a position determining means 4, and a maintenance and security descriptor library 5.

Application-specific program code is devised and provided to execute control logic which regulates transactions between various of system components. Code is prepared with knowledge and understanding of system objectives and system architecture with particular respect to maintenance and security and attributes of maintenance and security. The code which is particular to the structure and nature of all elements taught herein, is stored in a manner whereby it may be executed from time-to-time when the device is performing in normal use.

A position determining means such as GPS receiver is arranged with its reference point coupled with the device—that is, it is set to deter the position/location wherever the electronic appliance is at any given time. In most versions this merely means locating the GPS antenna within the system primary hardware, While elements of these systems may be implemented as distributed systems, i.e. in particular the maintenance and security library, there is a primary hardware unit which is necessarily mobile and serves as a position reference for cooperating parts.

The maintenance and security library 5 includes prescribed data stored in a data storage apparatus and may be deployed as a conventional database. These databases include mechanisms such as custom-designed schema. Stored data includes at least one but usually a plurality of maintenance and security descriptors 6, A maintenance and security descriptor is comprised of a handle, a parameter list such as name-value pairs, executable code, and sometimes one or more images, videos, and other multi-media data, One most important element of a site descriptor is a geometric construct and definition of a viewpoint or viewing vantage point for best performing the set routine or task. There is a one-to-one correspondence between site descriptor data records and viewpoints. That is, each site descriptor includes exactly one viewpoint.

Another important feature of any specific site descriptor is its associations. By way of various parameters or record fields, a site descriptor forms an association with some reference(s). This is useful for sorting operations. In one example, a certain site descriptor may have an association with a sub location—for example: oil well head. In another example, a site data record may have an association with a particular function. Fresh water supply is an important function to some maintenance and security operations. For purposes of this discussion, a ‘result set’ collection of site descriptors is generally particular to some common subject matter which makes a good visitor site such as a equipment like the Washington Monument. Thus, any subject of maintenance and security workers interest may be represented by a ‘view site’ which contains information about the site and these are part of the site descriptors. It is important to understand that the viewpoint specification of any view site or visit site or ‘object’ is generally not co-located with the actual subject being viewed or addressed. In other words, the location of the site viewpoint is normally different than the position in which the subject of viewing lies. A particular range to a site is also of importance since proper inspection or viewing is a vital part of maintenance and security routines.

Many other types of associations are also useful. For example, a certain site descriptor may include a time association—for example: night door checks. Since some objects of interest have particular attributes which are present only at a certain time, for example cleaning oil pumps at night or the checking of an oil refinery's gates and doors during non-production hours, these sites would have a time marker as part of the site specification or site descriptor. Many other site descriptor associations will become more apparent in consideration of examples presented in detail here following. It should be further appreciated that while not all possible associations can be described here due to the fact that their number is infinitely great—one will understand that the essence and core of the invention doesn't change when a new type of association is introduced and applied as part of a site descriptor. The principal which is to be clearly understood is that associations may be attached to site descriptors; and sorting and recall based upon such association may be affected.

The position determining means conveys position data to the computer in response to an initialization step and sometimes continuously throughout operation. Based upon position information received, among other information such as association specifications, a query engine 7 forms a database query to recall stored information. A result set (plurality of site descriptors) 8 is returned to the computer—and this result set includes all site descriptors which meet the parameter definitions of the query. A result set may include one or more site descriptors and together these belong to an organized maintenance and security routine and procedure.

These site descriptors and parts thereof may be reviewed and examined by a user. Application-specific code is arranged to parse the site descriptors and ‘play’ or present them, in example, one-by-one at a display type visual user interface 9, Most particularly, images and video 10 and other multi-media may be presented alongside with graphic and text/numeric data.

While viewing site descriptors, a user may use a control module 11 with tactile peripherals such as a key switches 12 or thumbwheel 13 to interact with the application in consideration with the site descriptor presented. For example, a user may ‘select’ a particular site descriptor for further action. Users may interact via user interface with various parts of a site descriptor and the information it contains to express further desire for additional information and content.

These components are preferably arranged into a form and format of a mobile computing package. A mobile computing package is suitable for incorporating a high resolution display type user interface and preferably a touch screen type device. The system is preferably small enough to be held in a single hand with a similar profile like a common mobile telephone. While a common tablet computer like an iPad device is a bit large, it nevertheless remains a useful size to implement these systems. A device such as an iPod Nano is too small to contain a meaningful display for purposes of information presentation in accordance with the types of information anticipated. A head worn device such as Google Glass may also be of benefit to the systems described herein. This would allow the site being viewed to be selected and noted by the position and pointing direction of the wearer's head; their direction of view.

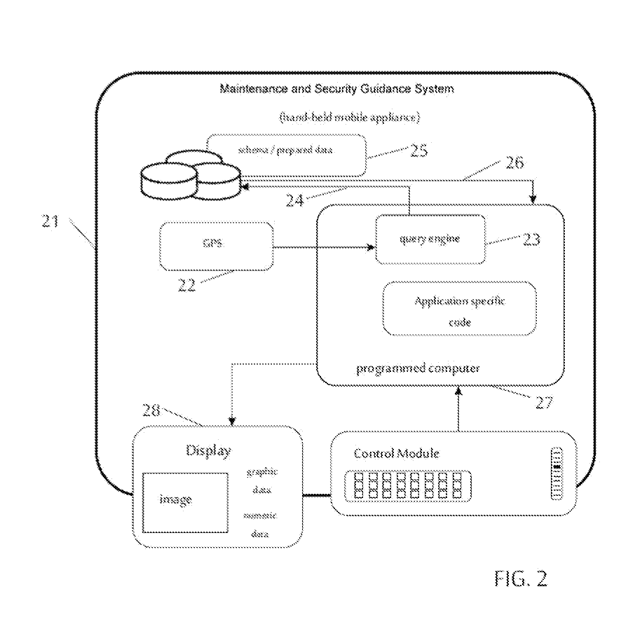

FIG. 2 describes via diagram an important version where the system is directly integrated as a hand-held mobile user appliance. In versions of these apparatus where a maintenance and security workers guidance system 21 is integrated as a hand-held mobile appliance, control commands generated by the system in agreement with a user selected site descriptors whereby operational states of the appliance are adjusted in accordance with the site descriptor parameter details. In these versions, a GPS 22 for example determines location data with respect to the position of the device and conveys same to the query engine 23 which generates a database query 24 in view of a prescribed arrangement of stored maintenance and security data—each unique site having associated therewith a viewpoint spatial construct. That is, the database schema and prepared data 25 are sometimes provided with a consideration of the location and nature from which a site is best viewed to be maintained and checked according to a prescribed recommendation. Details 26 regarding site viewpoint are passed with a site descriptor to the processor 27 for arrangement and presentation to a user viewer at a display 28 where it may be consumed visually. In addition, other site viewing information may include view orientation, history, site data such as architectural information, hours of operation, et cetera. Recalling from the description of FIG. 1, a user may select one from a plurality of site descriptors from which any particular maintenance and security parameter is comprised. Once a site descriptor is chosen, it may be used by the application-specific code to drive the user interface to expose information related to the chosen site. In review, a user may take a mobile unit of these systems to a site of interest and automatically receive viewing and task related suggestions and other information related to the site being addressed. A user may further specify viewing related parameters such as ‘pumps’ to limit or narrow the scope of the subject matter offered as site viewing suggestions. Upon choosing any particular parameter like ‘pumps’ from a group of possible choices in the result set, the computing system presents the user with details which can be used by the user-maintenance and security workers to bring about an actual view plan similar to the one suggested. In this way, a user can be directed to view that which might include important and vital equipment, or assets known to be associated with the site of interest being addressed. Foremost among these, is a viewing vantage or site viewpoint. A user may specify that they would like to view the Well Head with a list of parts to check and maintain. On the selection, the computer directs the user to a particular viewpoint where the maintenance and security worker can access the site from the particular specified parameters. The computer ‘knows’ of this viewpoint because information stored in the maintenance and security library have attached thereto a geometric definition of the site and its associated viewpoints. Once a user arrives in the viewpoint location specified by the site descriptor, the device can further present information relating to the site to the user at the graphical user interface. Information presented is particular to the site, and even still further to the precise viewpoint from which the site is viewed.

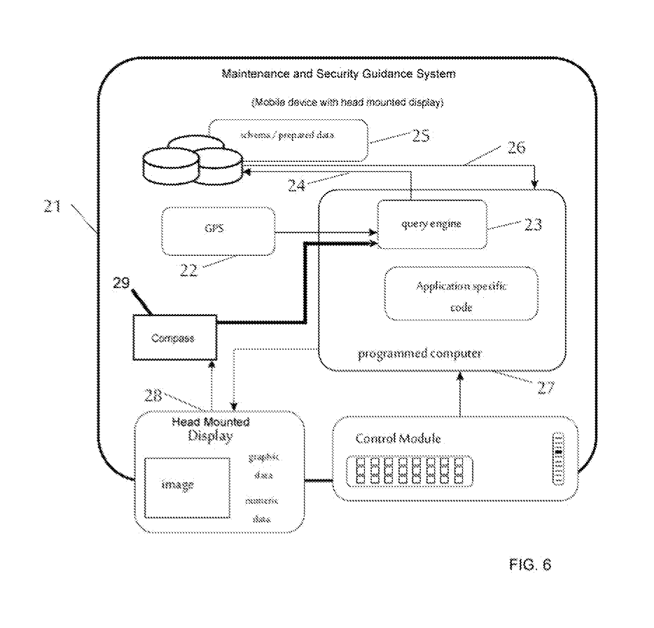

FIG. 6 describes via diagram an important version where the system is directly integrated as a mobile user appliance with a head mounted display. In versions of these apparatus where a maintenance and security workers guidance system 21 is integrated as a mobile appliance with a head mounted display, control commands generated by the system in agreement with a user selected site descriptors whereby operational states of the appliance are adjusted in accordance with the site descriptor parameter details. In these versions, a GPS 22 for example determines location data with respect to the position of the device and conveys same to the query engine 23 which generates a database query 24 in view of a prescribed arrangement of stored maintenance and security data—each unique site having associated therewith a viewpoint spatial construct. That is, the database schema and prepared data 25 are sometimes provided with a consideration of the location and nature from which a site is best viewed to be maintained and checked according to a prescribed recommendation. Details 26 regarding site viewpoint are passed with a site descriptor to the processor 27 for arrangement and presentation to a user viewer at a head mounted display 28 where it may be consumed visually. A compass 29 is also coupled to the head mounted display to determine the viewing direction of the user.

Another most important aspect of these maintenance and security guidance systems relates to maintenance and security management. In some best embodiments of maintenance and security tasks which are comprised of a discrete set of specific sites, the maintenance and security task is considered complete once each site has been visited. Because some maintenance and security tasks may be constructed without a logical path of sites to be followed in sequence, but rather the sites may be visited in a random access scheme, it is useful to include a ‘reporting’ and/or recording mechanism by which site visited are ‘checked off’ a list. A list of the sites from which a particular maintenance and security task is comprised is associated with a status feature which indicates that a site visit is or is not complete. As a user goes from site to site, the status is updated or the site is associated with a completed visit. A checklist is ticked to indicate the site visit has been made. The maintenance and security which comprises of a plurality of related sites—includes one status state for each to indicate whether or not a completed visit is made. In the way, a user can progress down the list or in any random order to ‘check-off’ those visited sites. By easy reference to the check list of sites/visited sites, a user quickly learns which sites remain due for a visit before the maintenance and security routine is completed.

In some versions, a checklist is operated as an automated system. An electronic determination is made to verify that a site has been visited as part of a maintenance and security operation or routine. When the spatial conditions are met to satisfy some prescribed criteria for a site visit, the checklist is marked as ‘visited’ or ‘maintained.’ That is, the status indicator provided to maintain a log of visited sites is set into a state to reflect the site was visited or maintained by the user. For this, the prescribed criteria may include: user location, distance to site, viewing orientation, device location and orientation and time of day, among others.

In still another alternative, a user can manually ‘mark’ that a site has been visited in agreement with subjective criteria which may be dynamic in time. For example, a user having less interest in some types of sites which are part of a maintenance and security routine might visit them quite briefly or superficially but still want them to be marked as ‘visited,’ ‘viewed’ or ‘completed.’ A user interface is provided to set/reset the state of the visited status indicators for each site of a maintenance and security. The user can maintain this checklist to assist the progress of a selected maintenance and security being executed or followed.

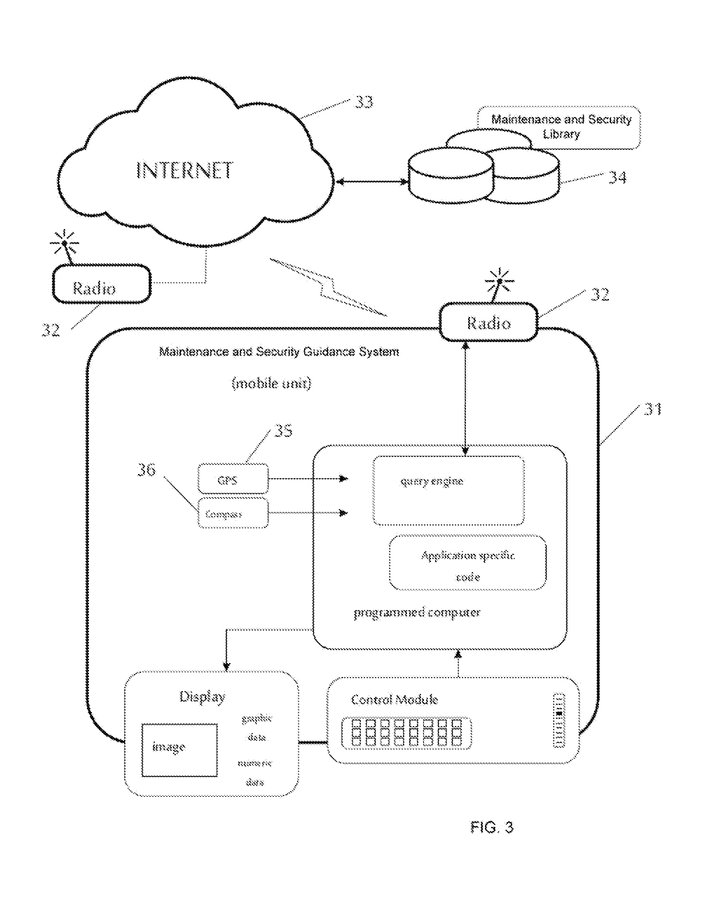

FIG. 3 illustrates important communications aspects of these maintenance and security guidance systems 31. Because some comprehensive versions of these systems include very complete libraries of site descriptors including frequent information updates, it becomes convenient to embody them as remote servers. A radio (wireless) communications link 32 is established whereby a mobile device as described is coupled to and exchanges messages with the remote server via the Internet 33. Calls to a remotely located maintenance and security library 34 (server) produce a reply over the same wireless communications link whereby the maintenance and security guidance system mobile unit receives a limited set of data including a plurality of highly relevant site descriptors. One will appreciate that mobile systems of limited memory and computing resources benefit when coupled to remote servers as described. In addition, self-contained versions with all data on-board are further limited with respect to frequent updates. Remotely deployed maintenance and security libraries offer real-time fresh updated data to all users who might couple therewith by a single one-time change at a library arranged as a remote server.

When a mobile unit is carried by a user to a site location or, the GPS 35 measures the device's position and reports position data to the application-specific programmed computer. In one special version, an electronic compass or inertial navigation system 36 may be also included. Device attitude information may also be used in some data queries to request a site descriptors via a more narrowly defined query. If a maintenance and security workers who uses these systems in the center of an oil field facing West, the compass can detect the pointing orientation or attitude of the mobile unit and provide the query engine this information. Thus merely pointing West from this location causes the maintenance and security descriptors to be recalled to all the derricks and equipment located in that direction as a subject of interest; Derricks 1-3. However, if the device is turned 180° and pointed East, then the result set returned only includes site descriptors of equipment located in that direction as a subject of interest; derricks 4-6. That is, the pointing attitude drives the query engine to recall data which relates to that which is being addressed or pointed at. Accordingly, both position and attitude can be used to form queries to recall specific site descriptors.

In one important version, the compass or inertial navigation system has a reference direction—for example a virtual line or geometric construct which corresponds to the package centerline—the direction which is subject to the attitude/orientation determination. When the hand-held or head mounted device is pointed, the compass determines the pointing direction of the device. Accordingly, recalled site recordsets (i.e. a plurality of site descriptors) can depend upon the instantaneous position and attitude of the hand-held device.

In systems 41 taught here, a site descriptor may further include information about the subject of the view being made. A maintenance and security worker in the above mentioned oil field pointing their device West with respect to reference vector 42 would automatically by way of the query engine 43 invoke recall of a site descriptor including a ‘title’ information set associated with the subject matter being viewed; i.e. “Derrick #1”. Accordingly, “Derrick #1” can be presented at a user interface 44 as a label for the site being addressed by the maintenance and security worker. In addition, other information relating specifically to the subject being viewed may also be saved as part of the image file—e.g. title; manufacturer; year built; maintenance history, et cetera. If the same user-maintenance and security worker then turned approximately 180° to face East and make another viewing, a site descriptor recalled would have a subject matter title “Derrick #4”. The user need not know about these titles in advance, the mere act of pointing the camera towards the subject being visited invokes an automatic change to label data displayed at the user interface.

One will now fully appreciate how maintenance and security guidance systems based upon computerized processing and stored information operable for making suggested images may be realized. Furthermore by sending a stream of information relating to the operation back to a secure storage facility the parties overseeing the safe and satisfactory operation of the facility have a record that may prove critical to improving the process of the facility and to provide a record to oversight that the maintenance and security provisions of any agreements are strictly adhered to. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

It is claimed:

1) Electronic maintenance and security guidance systems comprising:
a programmed computer;
a maintenance and security library;
an interactive control module; and
a display type user interface,
an audible type user interface
said maintenance and security library is coupled to said programmed computer whereby stored site descriptors may be recalled and presented at said display type or user interface, whereby said recalled maintenance and security descriptors characterize and express viewing states of a prescribed and predefined visit opportunity.

2) Electronic maintenance and security guidance systems of claim 1, said systems are integrated as a handheld self-contained system.

3) Electronic maintenance and security guidance systems of claim 1, part of said systems are comprised of a head mounted display.

4) Electronic maintenance and security guidance systems of claim 2, in the form and format of a mobile computing package.

5) Electronic maintenance and security guidance systems of claim 4, said systems are coupled to remote servers via radio transceivers characterized as WiFi or cellular communications networks and including satellite or cable systems where appropriate.

6) Electronic maintenance and security guidance systems of claim 1, said programmed computer is further characterized as comprising executable program code including a plurality of functional methods which may be invoked or called for execution by a control system or menu.

7) Electronic maintenance and security guidance systems of claim 1, said site descriptors include definitions of site viewing instances.

8) Electronic maintenance and security guidance systems of claim 7, each of said site descriptors are embodied as a program code objects with prescribed name-value pairs for object properties.

9) Electronic maintenance and security guidance systems of claim 7, said viewing instance is further characterized as including viewing states defined by either of: viewpoint, view orientation, and/or time of day.

10) Electronic maintenance and security guidance systems of claim 7, portions of said site descriptors are presented graphically at a user interface including a display device.

11) Electronic maintenance and security guidance systems of claim 1, further comprises a positioning determining means such as GPS, said site descriptor recall is based upon current position as determined by the positioning determining means.

12) Electronic maintenance and security guidance systems of claim 1, said programmed computer comprises application specific code arranged to administer a maintenance and security routine.

13) Electronic maintenance and security guidance systems of claim 12, said maintenance and security routine is characterized as presentation of a series of site descriptors in a logical manner.

14) Electronic maintenance and security guidance systems of claim 13, said logical manner includes an orderly spatial plan.

15) Electronic maintenance and security guidance systems of claim 13, said logical manner includes a plurality of viewpoints all coupled by a common equipment in a ‘walking maintenance and security routine’ characterized as taking place along a continuous walking route or path.

16) Electronic maintenance and security guidance systems of claim 14, said orderly spatial plan is characterized as synchronization with either from the group: well heads; entry and exit doors and gates; water pipes; and site maintenance and security.

17) Electronic maintenance and security guidance systems of claim 1, said programmed computer comprises application specific code arranged to administer a maintenance task.

18) Electronic maintenance and security guidance systems of claim 17, said maintenance task is characterized as an exploration of various past and future maintenance tasks.

19) Electronic maintenance and security guidance systems of claim 1, said systems further comprising a control module with tactile input systems.

20) Electronic maintenance and security guidance systems of claim 7, further comprising a site visit status checklist.

21) Electronic maintenance and security guidance systems of claim 20, said checklist further comprises status indicators one for each site, said indicators have binary states to indicate a completed task.

22) Electronic maintenance and security guidance systems of claim 20, said checklist further comprises a visual record, including time and date data, of each task.

23) Electronic maintenance and security guidance systems of claim 22, said visual record of each task is transmitted to one or more storage servers for record and verification of each task.
